(19) United States
(12) Patent Application Publication
(10) Pub. No.: US 2020/0307321 A1
(43) Pub. Date: Oct. 1, 2020

(54) PNEUMATIC TIRE

(71) Applicant: TOYO TIRE CORPORATION, Itami-shi (JP)

(72) Inventors: Jiro Taniguchi, Itami-shi (JP); Toshiyuki Ohashi, Itami-shi (JP)

(73) Assignee: TOYO TIRE CORPORATION, Itami-shi (JP)

(21) Appl. No.: 16/810,075

(22) Filed: Mar. 5, 2020

(30) Foreign Application Priority Data
Mar. 28, 2019 (JP) 2019-064585

(51) Int. Cl. B60C 11/12

(52) U.S. Cl. CPC B60C 11/1218

(57) ABSTRACT

A sipe is defined by a wall surface including a first side surface and a second side surface and that face each other with a gap therebetween. The first and second side surfaces each include a first portion on the surface side of the land section, a second portion on the bottom side of the sipe, and a third portion interposed between the first portion and the second portion. The first portion of the first side surface and the first portion of the second side surface have complementary shapes. The first portion of the first side surface and the first portion of the second side surface each have a shape having an amplitude in the sipe width direction from one end to the other end in the ripe extending direction, the amplitude gradually decreasing toward the bottom of the sipe from the surface of the land section.

### CROSS-REFERENCE TO RELATED APPLICATIONS

This application claims priority of Japanese Patent Application No.: 2019-064585 filed on Mar. 28, 2019, the content of which is incorporated herein by reference.

### BACKGROUND OF THE INVENTION

### Technical Field

The present invention relates to a pneumatic tire.

### Related Art

The sipe disclosed in Japanese Patent No. 4689402 includes a first portion on the surface side of a land section and a second portion on the side opposite to the surface of the land section with respect to the first portion. The shape of the sipe in the first portion has an amplitude in the sipe width direction from one end to the other end in the sipe extending direction. Further, the shape of the sipe in the first portion is constant without changing in the sipe depth direction. The shape of the sipe in the second portion has an amplitude in the sipe width direction toward the bottom of the sipe. The shapes of the sipe described above are intended to improve both performance on icy and snowy road surfaces and uneven wear resistance performance by suppressing collapse of the land section.

### SUMMARY

In the sipe disclosed in Japanese Patent No. 4689402, the shape of the sipe in the first portion does not change in the sipe depth direction as described above. Therefore, the flexibility of the land section in the first portion is uniform in the sipe depth direction. When the necessary flexibility is ensured on the surface of the land section from the viewpoint of improving performance on icy and snowy road surfaces, the flexibility tends to be excessive in the region of the first portion opposite to the surface. This tendency is not preferable from the viewpoint of suppressing collapse. On the other hand, when the flexibility of the region in the first portion on the side opposite to the surface is suppressed from the viewpoint of suppressing the collapse, the flexibility on the surface of the land section tends to be insufficient. This tendency is not preferable from the viewpoint of improving performance on icy and snowy road surfaces. For these reasons, the sipe disclosed in Japanese Patent No. 4689402 has room for further improvement in achieving both improvement in performance on icy and snowy road surfaces and improvement in uneven wear resistance performance by suppressing collapse of the land section.

An object of the present invention is to achieve both improvement in performance on icy and snowy road surfaces and improvement in uneven wear resistance performance by suppressing collapse of a land section in a pneumatic tire.

The present invention provides a pneumatic tire comprising a tread section having a land section formed with a sipe, wherein the sipe is defined by a wall surface including a first side surface and a second side surface that extend in a sipe extending direction and a sipe depth direction when viewed from a surface of the land section and that face each other with a gap therebetween in a sipe width direction, the first side surface and the second side surface each have a first portion located closer to the surface of the land section, a second portion located closer to a bottom of the sipe, and a third portion interposed between the first portion and the second portion, the first portion of the first side surface and the first portion of the second side surface have complementary shapes, and each of the first portion of the first side surface and the first portion of the second side surface has a shape having an amplitude in the sipe width direction from one end to the other end in the sipe extending direction, the amplitude gradually decreasing toward the bottom of the sipe from the surface of the land section.

The first portions which are portions closer to the surface of the land section in the first and second side surfaces defining the sipe each have an amplitude in the sipe width direction from one end to the other end in the sipe extending direction. Further, each of the first portions has a shape in which the amplitude gradually decreases from the surface of the land section toward the bottom of the sipe. That is, the shape of each of the first portions of the first and second side surfaces gradually changes from a shape having amplitude to a flat shape from the surface of the land section toward the bottom of the sipe. Due to the shapes of the first portions of the first and second side surfaces, flexibility of a region of the land section where the sipe is provided gradually decreases from the surface of the land section toward the bottom of the sipe. Therefore in the region of the land section where the sipe is provided, flexibility necessary to obtain desired performance on is and snowy road surfaces is ensured on the surface, while rigidity required to suppress collapse is ensured in an area of the first portion on the bottom side of the sipe. As a result, it is possible to achieve, at higher levels, both improvement in performance on icy and snowy road surfaces and improvement in uneven wear resistance performance by suppressing collapse of the land section.

Specifically, the first portion of the first side surface is provided with a first recess that extends from the surface of the land section toward the bottom of the sipe and is recessed in a direction away from the second side surface, and a first protrusion that is arranged adjacent to the first recess in the sipe extending direction, extends from the surface of the land section toward the bottom of the sipe, and protrudes toward the second side surface. The first portion of the second side surface is provided with a second protrusion that is arranged to face the first recess in the sipe width direction, extends from the surface of the land section toward the bottom of the sipe, and protrudes toward the first side surface, and a second recess that is arranged to face the first protrusion in the sipe width direction, extends from the surface of the land section toward the bottom of the sipe, and is recessed in a direction away from the first side surface. The first recess, the first protrusion, the second protrusion, and the second recess gradually decrease from the surface of the land section toward the bottom of the sipe and terminate.

The first recess, the first protrusion, the second protrusion, and the second recess may have a shape of a half cone pointed toward the bottom of the sipe.

The first recess, the first protrusion, the second protrusion, and the second recess may have a shape of a half circular cone pointed toward the bottom of the sipe.

The second portion of the first side surface and the second portion of the second side surface each have a shape having an amplitude in the sipe width direction toward the bottom of the sipe, the shape of the second portion of the first side surface and the shape of the second portion of the second side surface being complementary to each other.

Due to the configuration in which the second portions which are the portions on the bottom side of the sipe in the first and second side surfaces defining the sipe have such shapes, when a load which may cause collapse is applied to the region of the land section where the sipe is provided, such collapse can be prevented by the engagement between the second portion of the first side surface and the second portion of the second side surface.

Specifically, the second portion of the first side surface is provided with a third recess that extends in the sipe extending direction and is recessed in a direction away from the second side surface, and a third protrusion that is arranged adjacent to the third recess in the sipe depth direction, extends in the sipe extending direction, and protrudes toward the second side surface, and the second portion of the second side surface is provided with a fourth protrusion that is arranged to face the third recess in the sipe width direction, extends in the sipe extending direction, and protrudes toward the first side surface, and a fourth recess that is arranged to face the third protrusion in the sipe width direction, extends in the sipe extending direction, and is recessed in a direction away from the first side surface.

The third recess, the third protrusion, the fourth protrusion, and the fourth recess may he linear when viewed in the sipe width direction.

The third recess, the third protrusion, the fourth protrusion, and the fourth recess may meander when viewed in the sipe width direction.

Due to the configuration in which they meander, when a load is applied that may cause shear deformation in the region of the land section where the sipe is provided, that is, a load is applied that may displace the first side surface and the second side surface from each other in the sipe extending direction, the third recess and the fourth protrusion are engaged with each other, and the third protrusion and the fourth recess are engaged with each other. Due to such engagements, the shear deformation can be suppressed.

The third portion of each of the first side surface and the second side surface may have a flat surface.

The first portions (on the surface side of the land section) of the first and second side surfaces each have an amplitude in the sipe width direction from one end to the other end in the sipe extending direction. On the other hand, the second portions (on the bottom side of the sipe) of the first and second side surfaces each have an amplitude in the sipe width direction toward the bottom of the sipe. The third portions interposed between the first portions and the second portions having different amplitude modes as described above have flat surfaces, whereby a mutual effect between deformation of the land section in the first portions and deformation of the land section in the second portions can be reduced. As a result, the land section can reliably ensure the advantage due tee the gradual decrease in flexibility from the surface of the land section toward the bottom of the sipe in the first portions, and the land section can reliably ensure suppression of collapse in the second portions. In other words, due to the configuration in which the third portions of the first and second side surfaces have flat surfaces, it is possible to achieve, at higher levels, both improvement in performance on icy and snowy road surfaces and improvement in uneven wear resistance performance by suppressing collapse of the land section.

The pneumatic tire according to the present invention can achieve, at higher levels, both improvement in performance on icy and snowy road surfaces and improvement in uneven wear resistance performance by suppressing collapse of the land section.

### BRIEF DESCRIPTION OF THE DRAWINGS

The foregoing and the other features of the present invention will become apparent from the following description and drawings of an illustrative embodiment of the invention in which:

FIG. 1 is a schematic perspective view showing a block of a pneumatic tire according to an embodiment of the present invention;

FIG. 9 is a front view of a first side surface in a sipe width direction;

FIG. 3 is a perspective view of the first side surface;

FIG. 4 is a front view of a second side surface in the sipe width direction;

FIG. 5 is a perspective view of the second side surface;

FIG. 6 is a perspective view of a sipe blade; and

FIG. 7 is a view, similar to FIG. 2, showing a sipe according to a modification.

### DETAILED DESCRIPTION OF EMBODIMENTS

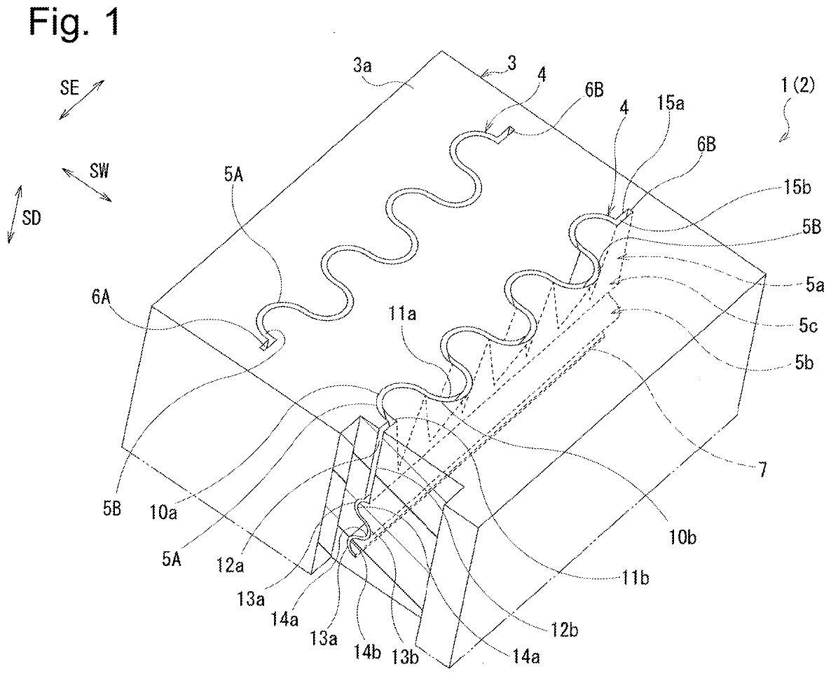

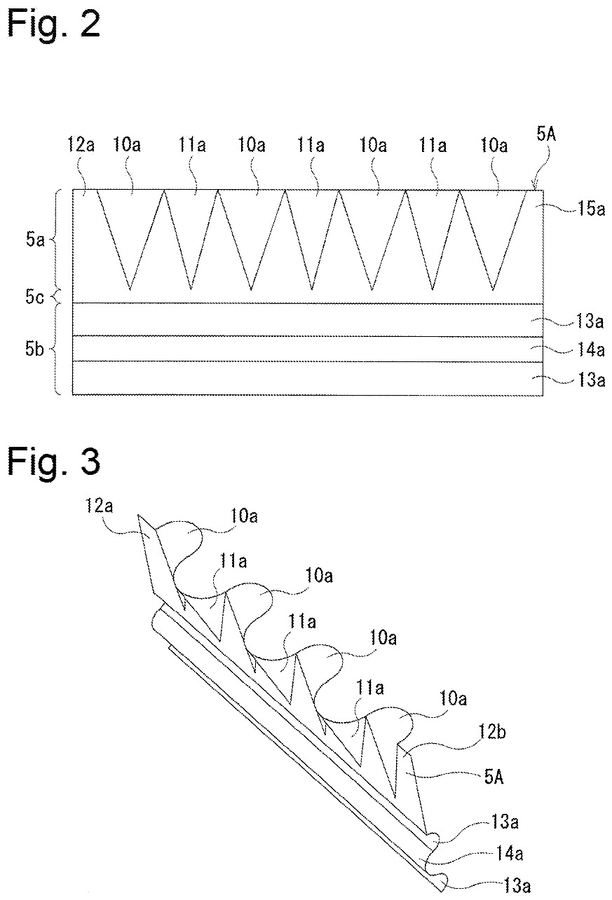

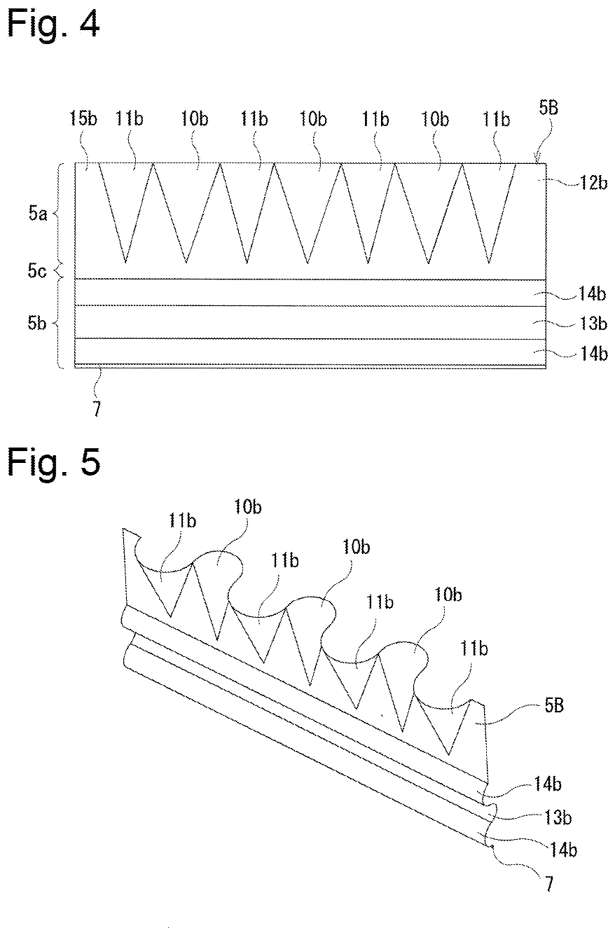

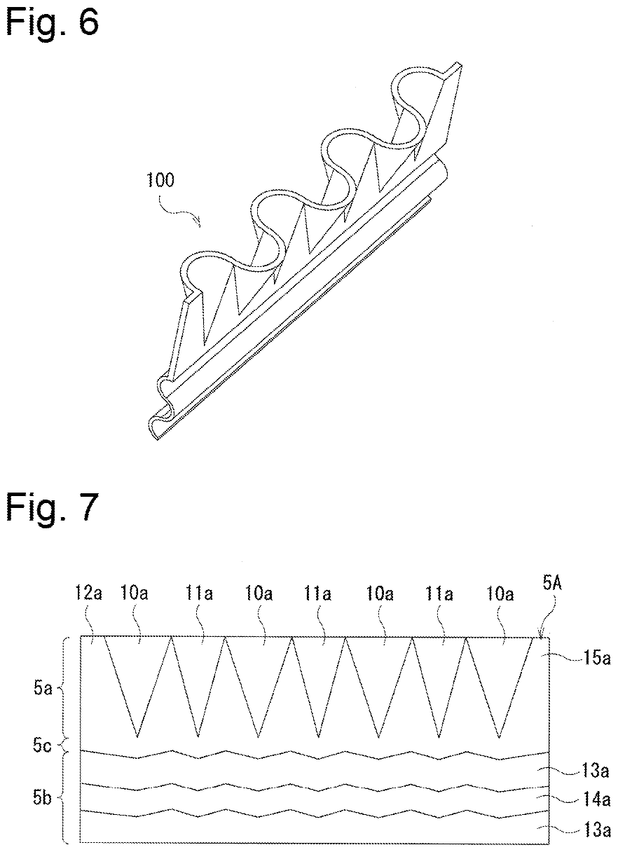

Referring to FIG. 1, a tread section 2 of a pneumatic tire 1 according to an embodiment of the present invention includes a block (land section) 3. A sipe 4 is formed in the block 3. In the present embodiment, the block 3 has a cuboid shape, and are provided with two sipes 4. The block 3 may have another shape, and the number of sipes 4 may be one or three or more. Further, the land section where the sipes 4 are formed may be a rib. The sipes 4 of the present embodiment can be formed by arranging a sipe blade 100 generally having a shape as shown in FIG. 6 at a proper position in a tire vulcanizing mold.

In FIG. 1, an arrow SE indicates the direction in which the sipes 4 extend when viewed from the surface 3a of the block 3, that is, the sipe extending direction. In FIG. 1, an arrow SD indicates the direction in which the sipes 4 extend inward in the tire radial direction from the surface 3a of the block 3, that is, the sipe depth direction. Further, in FIG. 1, an arrow SW indicates the sipe width direction.

In the following description, FIGS. 1 to 5, particularly FIG. 1, are referred, unless otherwise specified.

Each of the sipes 4 opens at the surface 3a of the block 3. The sipe 4 is defined by five wall surfaces, that is, a first side surface 5A, a second side surface 5B, a first end surface 6A, a second end surface 6B, and a bottom surface 7. The first side surface 5A and the second side surface 5B extend in the sipe extending direction SE and the sipe depth direction SD, and face each other with a gap therebetween in the sipe width direction SW. The first end surface 6A and the second end surface 6B extend in the sipe width direction SW and the sipe depth direction SD so as to connect the ends of the first side surface 5A and the second side surface 5B in the sipe extending direction SE, and face each other in the sipe extending direction SE. In the present embodiment, the first end surface 6A and the second end surface 6B are both flat surfaces. In the present embodiment, the bottom surface 7 extends in the sipe extending direction SE and the sipe depth direction SD.

The first, side surface 5A and the second side surface 5B are each provided with protrusions and recesses, and have complementary shapes. Here, the complementary shape means that, in an area where one of the first side surface 5A and the second side surface 5B has a protruding shape, the other has a recessed shape, and when at least no load is applied, the first side surface 5A and the second side surface 5B are not in contact with each other, and there is a gap between them in the sipe width direction SW.

The first side surface 5A and the second side surface 5B are divided into three portions in the sipe depth direction SD. That is, the first side surface 5A and the second side surface 5B each include a first portion 5a on the surface 3a side of the block 3, a second portion 5b on the bottom side (the bottom surface 7 side) of the sipe 4, and a third portion 5c interposed between the first portion 5a and the second portion 5b.

The first portion 5a of the first side surface 5A and the first portion 5a of the second side surface SB are not flat surfaces, and each have an amplitude in the sipe width direction SW from one end to the other end in the sipe extending direction SE. The amplitude gradually decreases from the surface 3a of the block 3 toward the bottom of the sipe 4, Furthermore, the first portion 5a of the first side surface 5A and the first portion 5a of the second side surface SB have complementary shapes. Hereinafter, the shapes of the first portions 5a of the first and second side surfaces 5A and 5B will be specifically described.

Referring to FIGS. 1, 2, and 3, the first portion 5a of the first side surface SA has a plurality of recesses (first recesses) 10a extending from the surface 3a of the block 3 toward the bottom of the sipe 4, and a plurality of protrusions (first protrusions) 11a extending similarly from the surface 3a of the block 3 toward the bottom of the sipe 4. Each recess 10a is recessed in a direction away from the second side surface 5B, and each protrusion I la protrudes toward the second side surface 5B. The recesses 10a and the protrusions 11 a are alternately arranged in the sipe extending direction SE. Both the recesses 10a and the protrusions 11a are gradually reduced from the surface 3a of the block 3 toward the bottom of the sipe 4 and terminate. In the present embodiment, each of the recesses 10a and each of the protrusions 11a have a shape of a half circular cone pointed toward the bottom of the sipe 4, and are approximately the same in shape and dimension. The first portion 5a of the first side surface 5A has flat surfaces 12a and 15a at both ends in the sipe extending direction SE.

Referring to FIGS. 1, 4 and 5, the first portion 5a of the second side surface 5B has a plurality of protrusions (second protrusions) 11b extending from the surface 3a of the block 3 toward the bottom of the sipe 4, and a plurality of recesses (second recesses) 10b extending similarly from the surface 3a of the block 3 toward the bottom of the sipe 4. Each protrusion 11b protrudes toward the first side surface 5A, and each recess 10b is recessed in a direction away from the first side surface 5A. The protrusions 11b and the recesses 10b are alternately arranged in the sipe extending direction SE. The first portion 5a of the second side surface 5B has flat surfaces 12b and 15b at both ends in the sipe extending direction SE.

The protrusions 11b and the recesses 10b included in the first portion 5a of the second side surface 5B have an arrangement, shape, and dimension corresponding to the recesses 10a and the protrusions 11a included in the first portion 5a of the first side surface 5A. First, the protrusions 11b are arranged to face the recesses 10a in the sipe width direction SW, and the recesses 10b are arranged to face the protrusions 11a in the sipe width direction SW. Similar to the protrusion 11a, each of the protrusions 11b has a shape of a half circular cone pointed toward the bottom of the sipe 4, and is the same as the protrusion 11a in shape and dimension. Further, similar to the recess 10a, the recess 10b has a shape of a half circular cone pointed toward the bottom of the sipe 4, and is the same as the recess 10a in shape and dimension

Since the first portions 5a of the first and second side surfaces 5A and 5B include the recesses 10a and 10b and the protrusions 11a and 11b as described above, a corrugated edge is formed by the first side surface 5A (first portion 5a) and the surface 3a of the block 3 or the second side surface 5B (first portion 5a) and the surface 3a of the block 3. The edge having such a shape can ensure a longer edge length as compared with an edge having a straight shape, thereby contributing to improvement in performance on icy and snowy road surfaces.

The specific shapes of the recesses 10a and 10b and the protrusions 11a and 11b are not particularly limited as long as they are gradually reduced toward the bottom of the sipe 4 and terminate. For example, the recesses 10a and 10b and the protrusions 11a and 11b may have a shape of a half cone not included in the category of a half circular cone, such as a shape of a half quadrangular pyramid or a shape of a half triangular pyramid. In the present embodiment, the recesses 10a and the protrusions 11a are continuous, and the protrusions 11b arid the recesses 10b are continuous, on the surface 3a of the block 3. However, on the surface 3a of the block 3, linear portions may be present between the recesses 10a and the protrusions 11a and between the protrusions 11b and the recesses 10b.

As shown most clearly in FIGS. 2 and 4, in the present embodiment, the positions of the termination portions of the recesses 10a and 10b and the protrusions 11a and 11b that is, the positions of the apexes of the half circular cones in the sipe depth direction SD are set to be the same. However, the positions of the termination portions of the recesses 10a and 10b and the protrusions 11a and 11b in the sipe depth direction SD may vary regularly or irregularly in the sipe extending direction SE.

In the present embodiment, the recesses 10a and 10b and the protrusions 11a and 11b (half circular cones) are the same in dimension and shape. Therefore, the sipe 4 has a corrugated shape having a constant amplitude and cycle when viewed from the surface 3a of the block 3. However, the recesses 10a and 10b and the protrusions 11a and 11b may regularly or irregularly vary in dimension and shape in the sipe extending direction SE. For example, one or both of the amplitude and the cycle of the shape of the sipe 4 viewed from the surface 3a of the block 3 may vary regularly or irregularly.

The first portions 5a of the first and second side surfaces 5A and 5B gradually change from a shape having amplitude to a flat shape from the surface 3a of the block 3 toward the bottom of the sipe 4. Due to such shapes of the first portions 5a of the first and second side surfaces 5A and 5B, flexibility of the region in the block 3 where the sipe 4 is provided gradually decreases from the surface 3a of the block 3 toward the bottom of the sipe 4. Therefore, in the region of the block 3 where the sipe 4 is provided, flexibility necessary to obtain desired performance on icy and snowy road surfaces is ensured on the surface 3a, while rigidity required to suppress the collapse is ensured in the region of the first portion 5a on the bottom side of the sipe 4. As a result, it, is possible to achieve, at higher levels, both improvement in performance on icy and snowy road surfaces and improvement in uneven wear resistance performance by suppressing collapse of the land section.

The second portion 5b of the first side surface 5A and the second portion 5b of the second side surface 5B are not flat surfaces, but have an amplitude in the sipe width direction SW toward the bottom of the sipe 4. In the present embodiment, this amplitude is constant, without changing, from one end to the other end in the sipe extending direction SE of the sipe 4. Further, the second portion 5b of the first side surface 5A and the second portion 5b of the second side surface 5B have complementary shapes. Hereinafter, the shapes of the second portions 5b of the first and second side surfaces 5A and 5B will be specifically described.

Referring to FIGS. 1, 2, and 3, the second portion 5b of the first side surface 5A has two recesses (third recesses) 13a extending in the sipe extending direction SE, and one protrusion (third protrusion) 14a formed between the two recesses 13a so as to extend in the sipe extending direction SE. Each recess 13a is recessed in a direction away from the second side surface 5B, and the protrusion 14a protrudes toward the second side surface 5B. In the present embodiment, the recesses 13a and the protrusion 14a have a semicircular shape in cross section perpendicular to the sipe extending direction SE, and are approximately the same in shape and dimension. Further, in the present embodiment, when the first side surface 5A is viewed from front in the sipe width direction SW, the recesses 13a and the protrusion 14a extend linearly in the sipe extending direction SE without meandering.

Referring to FIGS. 1, 4, and 5, the second portion 5b of the second side surface 5B has two protrusions (fourth protrusions) 14b extending in the sipe extending direction SE, and one recess (fourth recess) 13b formed between the two protrusions 14b so as to extend in the sipe extending direction SE. Each protrusion 14b protrudes toward the first side surface 5A, and the recess 13b is recessed in a direction away from the first side surface 5A.

The protrusions 14b and the recess 13b included in the second portion 5b of the second side surface 5B have an arrangement, shape, and dimension corresponding to the recesses 13a and the protrusion 14a included in the second portion 5b of the first side surface 5A. First, the protrusions 14b are arranged to face the recesses 13a in the sipe width direction SW, and the recess 13b is arranged to face the protrusion 14a in the sipe width direction SW. Similar to the protrusion 14a, each of the protrusions 14b has a semicircular shape in cross section perpendicular to the sipe extending direction SE, and is the same as the protrusion 14a in shape and dimension. Further, similar to the recesses 13a, the recess 13b has a semicircular shape in cross section perpendicular to the sipe extending direction SE, and is the same as the recesses 13a in shape and dimension. When the second side surface 5B is viewed from front in the sipe width direction SW, the protrusions 14b and the recess 13b extend linearly in the sipe extending direction SE without meandering.

Due to the abovementioned shapes of the second portions 5a which are the bottom side portions of the sipe 4 in the first and second side surfaces 5A and 5B defining the sipe 4, when a load which may cause collapse is applied to the region of the block 3 where the sipe 4 is provided, such collapse can be prevented by the engagement between the recesses 13a and the protrusions 14b and the engagement between the protrusion 14a and the recess 13b.

The cross sections perpendicular to the sipe extending direction SE of the recesses 13a and 13b and the protrusions 14a and 14b are not limited to have a semicircular shape as in the present embodiment, and may have an arc shape, an elliptical arc shape, or a polygonal shape such as a triangle, a rectangle, or a hexagon.

In the present embodiment, the recesses 13a and 13b and the protrusions 14a and 14b (arcs) are the same in dimension and shape. Therefore, the sipe 4 has a corrugated shape having a constant amplitude and cycle in cross section perpendicular to the sipe extending direction SE. However, the recesses 13a and 13b and the protrusions 14a and 14b may regularly or irregularly vary in dimension and shape in the sipe depth direction SD. For example, one or both of the amplitude and the cycle of the shapes of the second portions 5b of the sipe 4 in cross section perpendicular to the sipe extending direction SE may vary regularly or irregularly.

As in a modification shown in FIG. 7, the recesses 13a and 13b and the protrusions 14a and 14b may have a linear zigzag pattern when the first and second side surfaces 5A and 5B are viewed from front in the sipe width direction SW. Further, they may have a meandering shape, such as a corrugated shape, which does not fall within the category of a linear zigzag pattern. Due to the configuration in which they meander, when a load is applied that may cause shear deformation in the region of the block 3 where the sipe 4 is provided, that is, a load is applied that may displace the first side surface 5A and the second side surface 5B from each other in the sipe extending direction SE, the recesses 13a and the protrusions 14b are engaged with each other, and the protrusion 14a and the recess 13b are engaged with each other. Due to such engagements, the shear deformation can be suppressed.

As described above, in each of the first and second side surfaces 5A and 5B, the third portion 5c is inter posed between the first portion 5a on the surface 3a side of the block 3 and the second portion 5b on the bottom side of the sipe 4. More specifically, the third portion 5c of the first side surface 5A is defined as a portion between portions (apexes of the half circular cones) of the recess 10a and the protrusion 11a closest to the bottom of the sipe 4 and the portion of the recess 13a closest to the surface 3a side of the block 3. The third portion 5c of the second side surface 5B is defined as a portion between portions (apexes of the half circular cones) of the recess 10b and the protrusion 11b closest to the bottom side of the sipe 4 and the portion of the protrusion 14b closest to the surface 3a side of the block 3. In the present embodiment, the third portions 5c of the first and second side surfaces 5A and 5B are both flat surfaces without having recesses and protrusions.

The first portions 5a of the first and second side surfaces 5A and 5B (on the surface 3a side of the block 3) each have an amplitude in the sipe width direction from one end to the other end in the sipe extending direction SE. On the other hand, the second portions 5b (on the bottom side of the sipe 4) of the first and second side surfaces 5A and 5B each have an amplitude in the sipe width direction SW toward the bottom of the sipe 4. The third portions 5c interposed between the first portions 5a and the second portions 5b which have different amplitude modes as described above have flat surfaces, whereby a mutual effect between deformation of the block 3 in the first portions 5a and deformation of the block 3 in the second portions 5b can be reduced. As a result, the block 3 can reliably ensure the advantage due to the gradual decrease in flexibility from the surface 3a of the block 3 toward the bottom of the sipe 4 in the first portions 5a, and the block 3 can reliably ensure suppression of collapse in the second portions 5b. In other words, due to the configuration in which the third portions 5c of the first and second side surfaces 5A and 5B have flat surfaces, it is possible to achieve, at higher levels, both improvement in performance on icy and snowy road surfaces and improvement in uneven wear resistance performance by suppressing collapse of the land section.

What is claimed is:

1. A pneumatic. tire comprising a tread section having a land section formed with a sipe, wherein
the sipe is defined by a wail surface including a first side surface and a second side surface that extend in a sipe extending direction and a sipe depth direction when viewed from a surface of the land section and that face each other with a gap therebetween in a sipe width direction,
the first side surface and the second side surface each have a first portion located closer to the surface of the land section, a second portion located closer to a bottom of the sipe, and a third portion interposed between the first portion and the second portion,
the first portion of the first side surface and the first portion of the second side surface have complementary shapes, and
each of the first portion of the first side surface and the first portion of the second side surface has a shape having an amplitude in the sipe width direction from one end to the other end in the sipe extending direction, the amplitude gradually decreasing toward the bottom of the sipe from the surface of the land section.

2. The pneumatic tire according to claim 1, wherein
the first portion of the first side surface is provided with a first recess that extends toward the bottom of the sipe from the surface of the land section and that is recessed in a direction away from the second side surface, and a first protrusion that is arranged adjacent to the first recess in the sipe extending direction, extends from the surface of the land section toward the bottom of the sipe, and protrudes toward the second side surface,
the first portion of the second side surface is provided with a second protrusion that is arranged to face the first recess in the sipe width direction, extends from the surface of the land section toward the bottom of the sipe, and protrudes toward the first side surface, and a second recess that is arranged to face the first protrusion in the sipe width direction, extends from the surface of the land section toward the bottom of the sipe, and is recessed in a direction away from the first side surface, and
the first recess, the first protrusion, the second protrusion, and the second recess gradually decrease from the surface of the land section toward the bottom of the sipe and terminate.

3. The pneumatic tire according to claim 2, wherein the first recess), the first protrusion, the second protrusion, and the second recess have a shape of a half cone pointed toward the bottom of the sipe.

4. The pneumatic tire according to claim 3, wherein the first recess, the first protrusion, the second protrusion, and the second recess have a shape of a half circular cone pointed toward the bottom of the sipe.

5. The pneumatic tire according to claim 1, wherein the second portion of the first side surface and the second portion of the second side surface each have a shape having an amplitude in the sipe width direction toward the bottom of the sipe, the shape of the second portion of the first side surface and the shape of the second portion of the second side surface being complementary to each other.

6. The pneumatic tire according to claim 5, wherein the second portion of the first side surface is provided with a third recess that extends in the sipe extending direction and is recessed in a direction away from the second side surface, and a third protrusion that is arranged adjacent to the third recess in the sipe depth direction, extends in the sipe extending direction, and protrudes toward the second side surface, and
the second portion of the second side surface is provided with a fourth protrusion that is arranged to face the third recess in the sipe width direction, extends in the sipe extending direction, and protrudes toward the first side surface, and a fourth recess that is arranged to face the third protrusion in the sipe width direction, extends in the sipe extending direction, and is recessed in a direction away from the first side surface.

7. The pneumatic tire according to claim 6, wherein the third recess, the third protrusion, the fourth protrusion, and the fourth recess are linear when viewed in the sipe width direction.

8. The pneumatic tire according to claim 6, wherein the third recess, the third protrusion, the fourth protrusion, and the fourth recess meander when viewed in the sipe width direction.

9. The pneumatic tire according to claim 5, wherein the third portion of each of the first side surface and the second side surface has a fiat surface.

10. The pneumatic tire according to claim 4, wherein the second portion of the first side surface and the second portion of the second side surface each have a shape having an amplitude in the sipe width direction toward the bottom of the sipe, the shape of the second portion of the first side surface and the shape of the second portion of the second side surface being complementary to each other.

11. The pneumatic tire according to claim 10, wherein the second portion of the first side surface is provided with a third recess that extends in the sipe extending direction and is recessed in a direction away from the second side surface, and a third protrusion that is arranged adjacent to the third recess in the sipe depth direction, extends in the sipe extending direction, and protrudes toward the second side surface, and
the second portion of the second side surface is provided with a fourth protrusion that is arranged to face the third recess in the sipe width direction, extends in the sipe extending direction, and protrudes toward the first side surface, and a fourth recess that is arranged to face the third protrusion in the sipe width direction, extends in the sipe extending direction, and is recessed in a direction away from the first side surface.

12. The pneumatic tire according to claim 11, wherein the third recess, the third protrusion, the fourth protrusion, and the fourth recess are linear when viewed in the sipe Width direction.

13. The pneumatic tire according to claim 11, wherein the third recess, the third protrusion, the fourth protrusion, and the fourth recess meander when viewed in the sipe width direction.

14. The pneumatic tire according to claim 10, wherein the third portion of each of the first side surface and the second side surface has a flat surface.
